(19) United States
(12) Patent Application Publication
(10) Pub. No.: US 2011/0011766 A1
(43) Pub. Date: Jan. 20, 2011

(54) Method and System for Customized Images

(76) Inventor: Jody Puckett, Port Washington, WI (US)

Correspondence Address: ABSOLUTE TECHNOLOGY LAW GROUP LLC, 3316 W. Wisconsin Avenue, MILWAUKEE, WI, 53208, US

(21) Appl. No.: 12/839,248

(22) Filed: Jul. 19, 2010

Related U.S. Application Data
(60) Provisional application No. 61/227,017, filed on Jul. 20, 2009.

(51) Int. Cl. B65D 69/00; B42D 1/00; B65H 31/00

(52) U.S. Cl. 206/575; 281/38; 271/207

(57) ABSTRACT

The present invention is a method and system for creating a memo pad with customizable images utilizing templates, padding compound, a specially adapted pressurizing component, and an economical paper having a weight, size and finish suitable for use with a photo printing tray.

### CROSS-REFERENCE TO RELATED APPLICATIONS

This application claims priority to U.S. Provisional Application No. 61/227,017 filed on Jul. 20, 2009.

### FIELD OF INVENTION

The present invention relates to the field of customized stationary products and more particularly to a method and kit for creating memo pads with customized images.

### BRIEF DESCRIPTION OF THE DRAWINGS

FIG. 1 illustrates an exemplary embodiment of a kit for creating memo pads with customized images.

FIG. 2a illustrates an exemplary embodiment of a padding clamp with rectangular-shaped pressurizing components for applying pressure to paper treated with a padding compound.

FIG. 2b illustrates an exemplary embodiment of a rectangular padding clamp being used on paper treated with a padding compound.

FIG. 3a illustrates an exemplary embodiment of a padding clamp with oval-shaped pressurizing components.

FIG. 3b illustrates an exemplary embodiment of an oval padding clamp being used on paper treated with a padding compound.

FIG. 4a illustrates an exemplary embodiment of a padding clamp with curved pressurizing components.

FIG. 4b illustrates an exemplary embodiment of a curved padding clamp being used on paper treated with a padding compound.

### GLOSSARY

As used herein, the term “cutting guide” refers to a component which assists a user in cutting paper to a desired size for a memo pad, and which may include a mechanical device, measuring device or stencil (e.g., to cut paper or scrap paper to a smaller and/or uniform size or shape). A cutting guide may be used to cut multiple sheets of paper simultaneously.

As used herein, the term “hanging display rack” refers to a component that arranges and suspends merchandise for viewing by potential purchasers.

As used herein, the term “image” refers to any picture, graphic, word or phrase, logo, symbol, icon, design, layout, and combinations thereof.

As used herein, the term “memo-sized” means having dimensions which are smaller than standard 8.5×11 inch sheets of paper.

As used herein, the term “padding clamp” refers to a component that distributes pressure evenly and/or appropriately across paper treated with an adhesive or padding compound. A padding clamp is designed to minimize the appearance of indentations or visible pressure marks on the paper.

As used herein, the term “padding compound” refers to any adhesive or binding substance functionally adapted to adhere sheets of paper together to create a pad.

As used herein, “pressurizing component” refers to a component of a padding clamp that is used to apply pressure to paper treated with an adhesive or padding compound. Pressurizing components may be of any shape or material known in the art. For example, pressuring components may rectangular, elliptical, I-beam shaped, u-shaped, oval or square, and may be made of a material other than metal, such as plastic, wood or glass. (Only exemplary embodiments of shapes are shown herein.)

As used herein, the term “standard personal printer” refers to inkjet and laser printers designed primarily for home or small business use.

As used herein, the term “template” refers to any electronic image which may be customized or modified, is capable of accommodating inserted images and text, or which physically serves as a cutting pattern or guide for creating letters, images or sized components to assist a user in creating an aesthetic effect for a memo pad.

As used herein, the term “tightening component” refers to a component of a padding clamp that adjusts the level of tension and/or pressure, and may include a vise, clamp, clip, weight, threaded component, bolt, screw or any other component that may be employed to adjust pressure/tension known in the art.

### BACKGROUND

The U.S. market for stationary and paper goods exceeds $21 billion per year. Greeting cards and personalized stationary make up a large segment of the market, resulting in fierce competition for niche markets and novel products.

In addition, stationary and memo pads, which are personally appealing or offer an expressive component or ability to add advertising indicia are well known in the art, and are often sold by printing companies, which offer standardized templates and designs. For example, memo pads can be personalized (e.g., with a name) or with the purchaser's design of choice. Memo pads may be imprinted with a company's logo and used for advertising purposes or as letterhead. Most commercial office settings use one or more forms of memo pads or small paper pads for notes and annotations (e.g., post-it notes).

Memo pads are within the stationary market segment. Memo pads are generally comprised of multiple sheets of paper that are adhered and may be blank or pre-printed for specific uses, such as use as a grocery list, chore list, meals list, instructions to a babysitter, etc.

One product that is commercially available is padding compound (e.g., Sparco Brand Padding Compound), a brush-on compound that allows the user to make personalized note pads. While padding compound is available, it is not widely available and typically must be specially ordered. Padding compounds are generally compatible with all types of paper and it is known in the art that such compounds may be used to make note pads out of scrap paper by adhering the pages of paper together when applied to an edge of a stack of paper.

A problem known in the art for creating memo pads with customized images is the need to purchase several supplies in order to create a memo pad as the supplies are separately marketed and must be individually purchased and reconstructed for use as a memo pad. In addition, it is difficult to cut standard printer paper, which is used in standard personal printers, to memo-sized dimensions. Hand-cutting or cutting the paper using a paper cutter results in pages of non-uniform size, which are not ideal for creating a memo pad. Furthermore, when standard printer paper is cut to memo-sized dimensions prior to printing, the paper is printed using the printer's photo tray. Because standard printer paper is thinner than the photo paper for which the photo tray is adapted, printing is typically unreliable. For example, the printer will often grab multiple sheets of paper at once, requiring the user to check each page to make sure it was printed.

Another problem is the need for a device that applies sufficient pressure to allow padding compound to set properly. If the individual sheets of paper are not held together tightly enough while the padding compound is drying, the memo pad will fall apart.

A further problem is the unreliable end result caused by the need to coordinate the steps of applying padding compound with an appropriate implement, finding a source of pressure to set the padding compound, locating paper which is adaptable for standard printers (e.g., a photo tray), and coordinating images which will have a desired aesthetic appearance and/or which will allow customization.

It is desirable to have a method and system that allow a user to create customized memo pads that are professional in appearance and uniform in quality.

### SUMMARY OF THE INVENTION

The present invention is a method and system for creating a uniform, quality memo pad with customized images. The method and system utilizes the photo printer tray found in commercially available printers without the additional cost of using standard photo-weight paper. The method and system is comprised of a plurality of sheets of identically cut paper suitable for printing using a photo tray, a cardboard or other stiff backing, padding compound, a tool for applying the padding compound, and a lightweight device capable of clamping the plurality of sheets of paper together after the padding compound is applied.

### DETAILED DESCRIPTION OF INVENTION

For promoting an understanding of the present invention, references are made in the text to exemplary embodiments of a method and system for creating memo pads with customizable images, only some of which are described herein. No limitations on the scope of the invention are intended by describing these exemplary embodiments. One of ordinary skill in the art will readily appreciate that alternate but functionally equivalent sizes, components, and materials may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

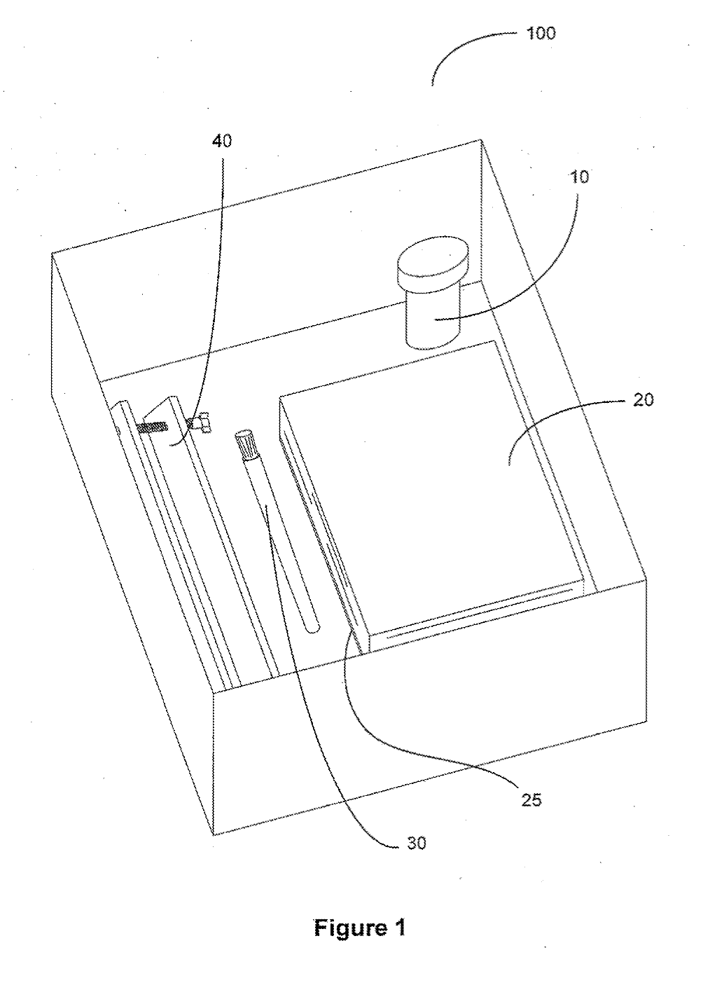

FIG. 1 illustrates an exemplary embodiment of a kit for creating memo pads with customized images 100 comprised of paper 20, backing 25, padding clamp 40, padding compound 10, and applicator 30 for applying padding compound 10.

To create a memo pad with customized images, the user selects one or more images (e.g., a digital image) and transfers those images to paper 20 by printing the images directly on paper 20 or by copying, adhering, or using any other means of transferring an image to paper known in the art. The user may choose to put the same image on each page of paper 20 or may choose to have applying different images to one or more of the pages.

In various embodiments, kit for creating memo pads with customized images 100 may further include a one or more marking devices including, but not limited to stamps, pens, paints, and dyes.

In the embodiment shown, paper 20 consists of a plurality of 4×6 inch sheets of specially weighted paper (e.g., 23 to 35 lb weight paper known in the art) capable of being loaded into a standard personal printer. In other embodiments, paper 20 may vary in dimensions, may be of any dimension smaller than 8.5×11 inches, and/or may be of lighter or heavier stock. In the embodiment shown, kit for creating memo pads with customized images 100 further includes backing component 25 which, in the embodiment shown, is a piece of cardboard or other rigid or semi-rigid cut to the approximate dimensions as paper 20 or dimensions which are complementary for purposes of creating a pad and providing a structural backing.

In various embodiments, padding compound 10 may be refillable, available in varying colors, and/or may be further decorated by adding dye, paint, color, and/or glitter.

In the embodiment shown, applicator 30 is a reusable brush, but in other embodiments, applicator 30 may be a sponge or another tool capable of applying padding compound 10. In various embodiments, applicator 30 may be reusable or disposable.

In other embodiments, kit for creating memo pads with customized images 100 may contain additional components, such as magnets for attaching the memo pad to a refrigerator or other surface, hooks for hanging the memo pad, ornamentation or other embellishments, a cover (e.g., similar to backing component 25 with additional aesthetic layers or features), and/or templates. In various embodiments, templates (not shown) to aid a user in creating his or her design may be stored on a computer storage or memory device or accessed by a user from a server. In various embodiments, templates may further include a database of images from which a user can select one or more images.

In other embodiments, kit for creating memo pads with customized images 100 may include an optional cutting guide component, stencils, cutting tools, straight edge components or any other device which may serve as a pattern and/or visual cue or guide.

In various embodiments, kit for creating memo pads with customized images 100 is packaged for storing and displaying on a shelf or hanging display rack. In various embodiments, kit for creating memo pads with customized images 100 may be specifically designed for easy transport. For example, kit for creating memo pads with customized images 100 may be package in a carrying apparatus with a handle.

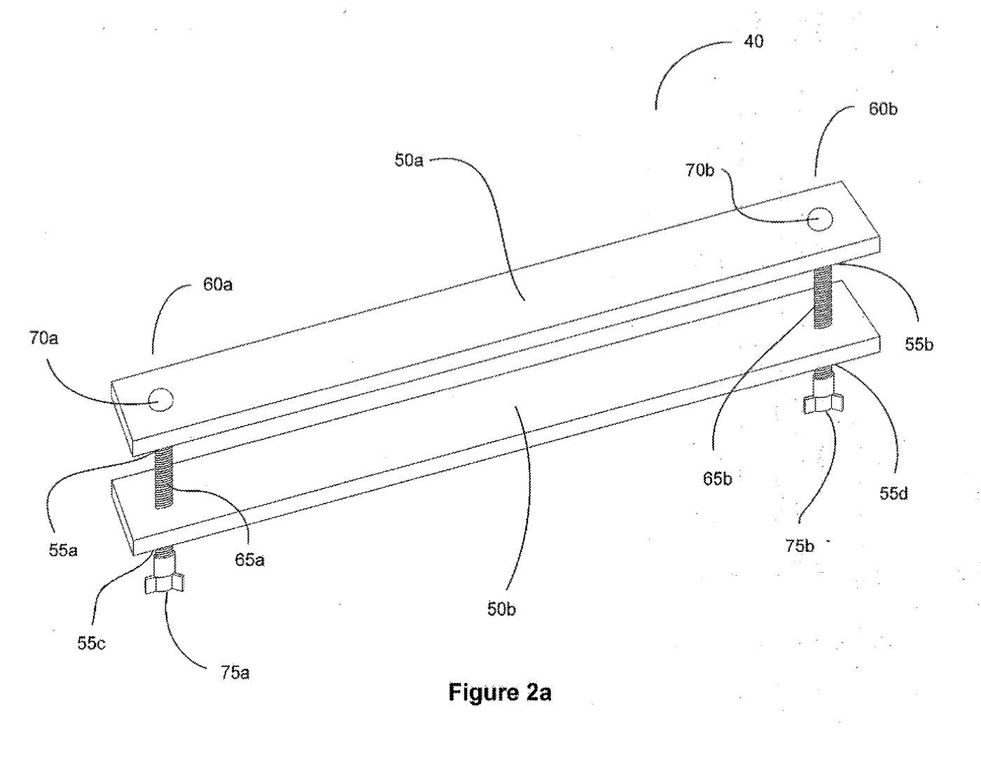

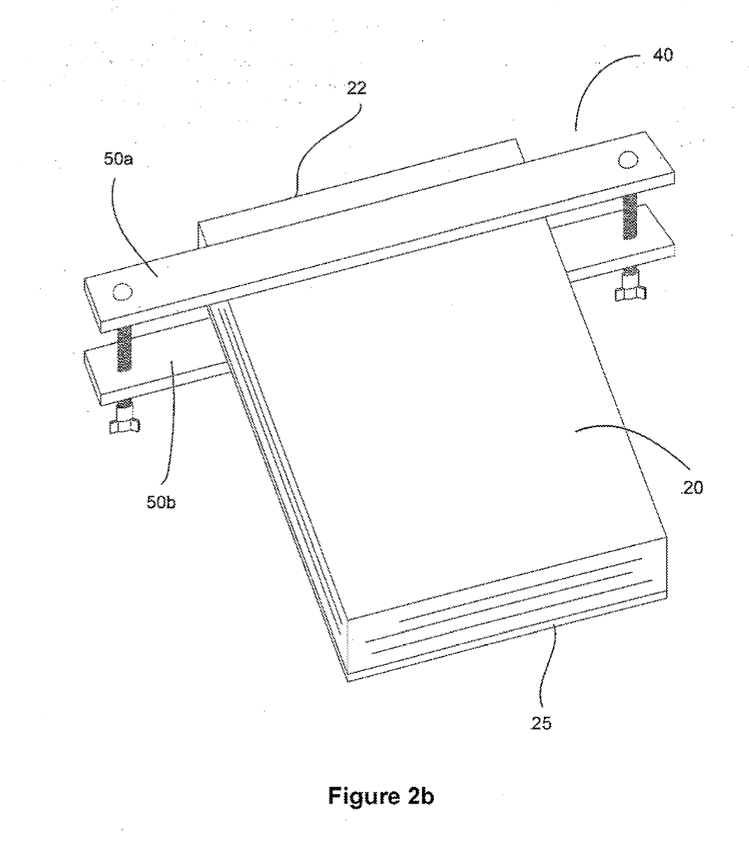

FIG. 2a illustrates an exemplary embodiment of padding clamp 40. In the embodiment shown, padding clamp 40 contains pressurizing components 50a, 50b and tightening components 60a, 60b. In the embodiment shown, pressurizing components 50a, 50b are rectangular and are made of metal. In other embodiments, pressurizing components 50a, 50b are of a shape other than rectangular, such as elliptical, i-shaped, oval, u-shaped, or square, and are made of a material other than metal, such as plastic, wood or glass.

In still other embodiments, padding clamp 40 may be disposable.

In the embodiment shown, pressurizing components 50a, 50b contain four apertures 55a, 55b, 55c, 55d sized to accommodate tightening components 60a, 60b. In the embodiment shown, tightening components 60a, 60b consist of screws 65a, 65b with heads 70a, 70b that are larger than apertures 55a, 55b and nuts 75a, 75b located on the other end of tightening components 60a, 60b. Nuts 75a, 75b are used to tighten pressurizing components 50a, 50. In other embodiments, tightening components 60a, 60b consist of components other than a screw and nut. Other embodiments may contain more, fewer or no apertures, and/or may utilize clamping components rather than tightening components.

FIG. 2b illustrates an exemplary embodiment of padding clamp 40 clamped around paper 20. In the embodiment shown, pressurizing components 50a, 50b are rectangular. Also visible is backing 25. Once padding clamp 40 has been tightened, padding compound 10 is applied to edge 22 of paper 20 nearest padding clamp 40.

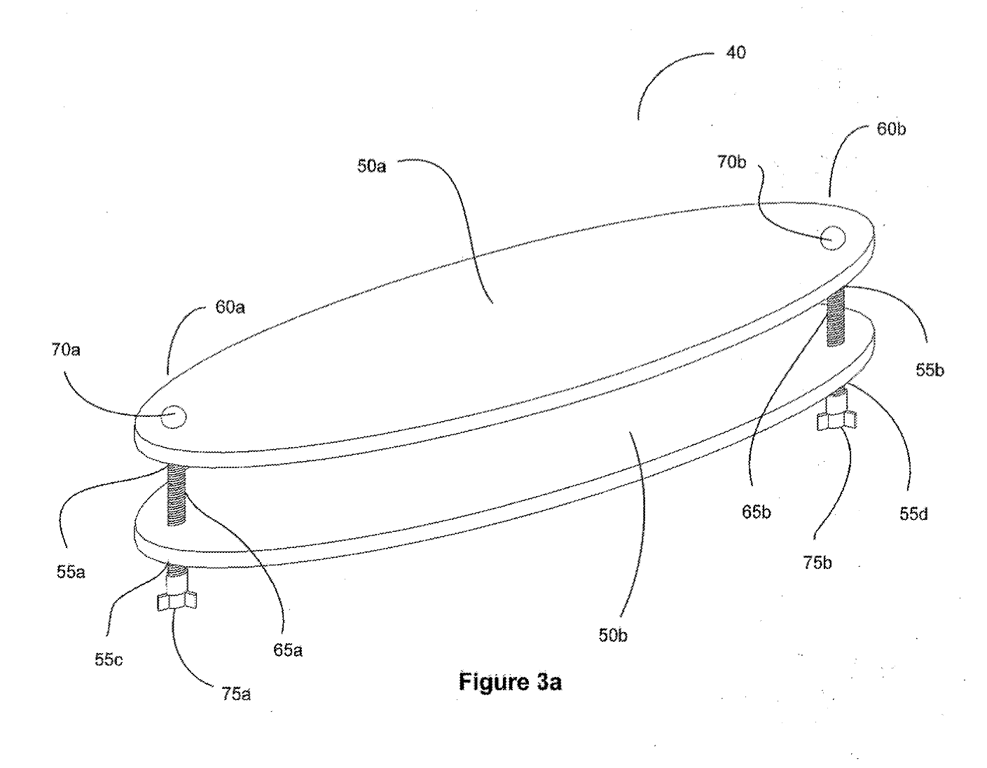

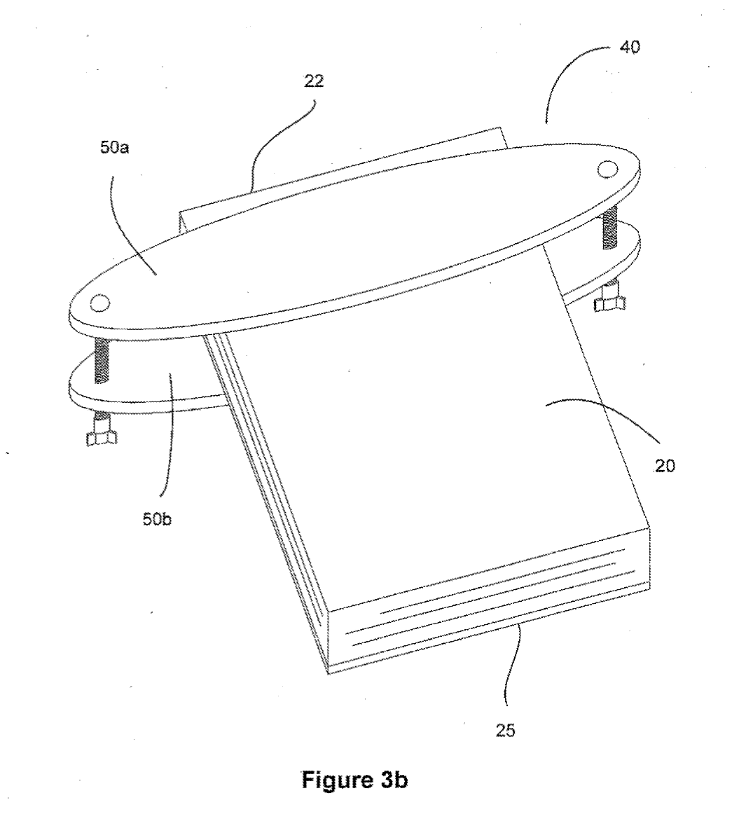

FIG. 3a illustrates a second exemplary embodiment of padding clamp 40. In the embodiment shown, padding clamp 40 contains pressurizing components 50a, 50b and tightening components 60a, 60b. In the embodiment shown, pressurizing components 50a, 50b are oval and are made of metal. In other embodiments, pressurizing components 50a, 50b are of a shape other than oval, such as rectangular, elliptical, i-shaped, or square, and are made of a material other than metal, such as plastic.

Pressurizing components 50a, 50b contain apertures 55a, 55b, 55c, 55d sized to accommodate tightening components 60a, 60b. In the embodiment shown, tightening components 60a, 60b consist of screws 65a, 65b with heads 70a, 70b that are larger than apertures 55a, 55b and nuts 75a, 75b located on the other end of tightening components 60a, 60b. Nuts 75a, 75b are used to tighten pressurizing components 50a, 50. In other embodiments, tightening components 60a, 60b consist of components other than a screw and nut.

FIG. 3b illustrates a second exemplary embodiment of padding clam 40 clamped around paper 20. In the embodiment shown, pressurizing components 50a, 50b are oval. Also visible is backing 25. Once padding clamp 40 has been tightened, padding compound 10 is applied to edge 22 of paper 20 nearest padding clamp 40.

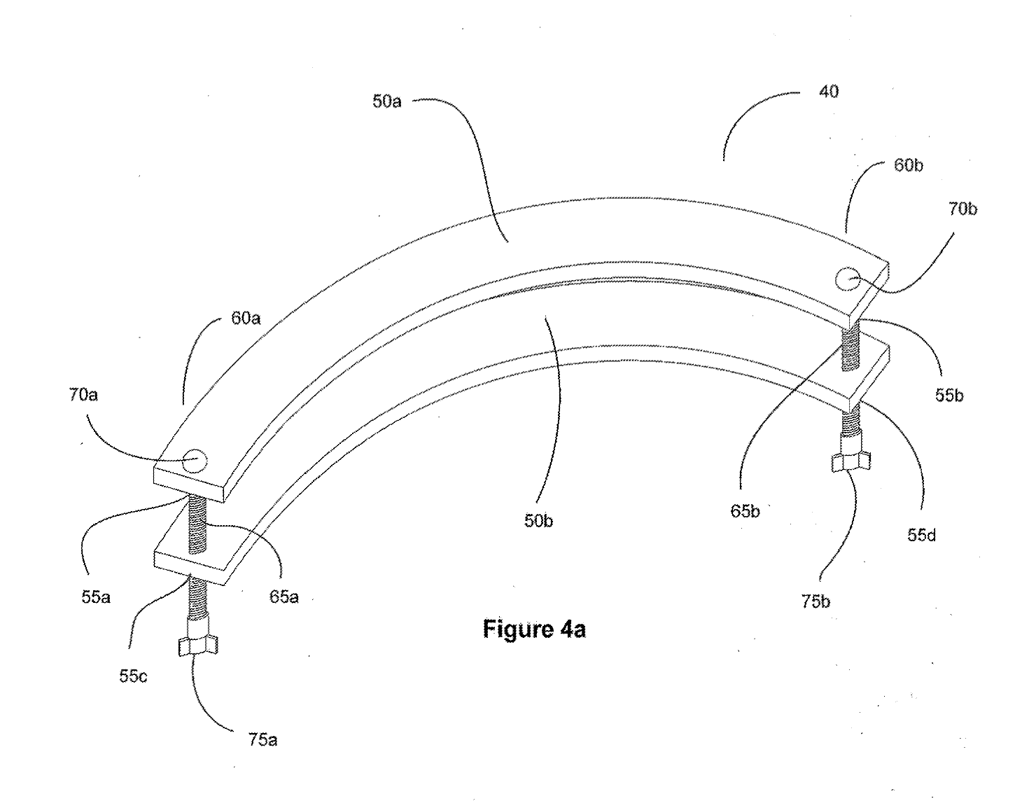

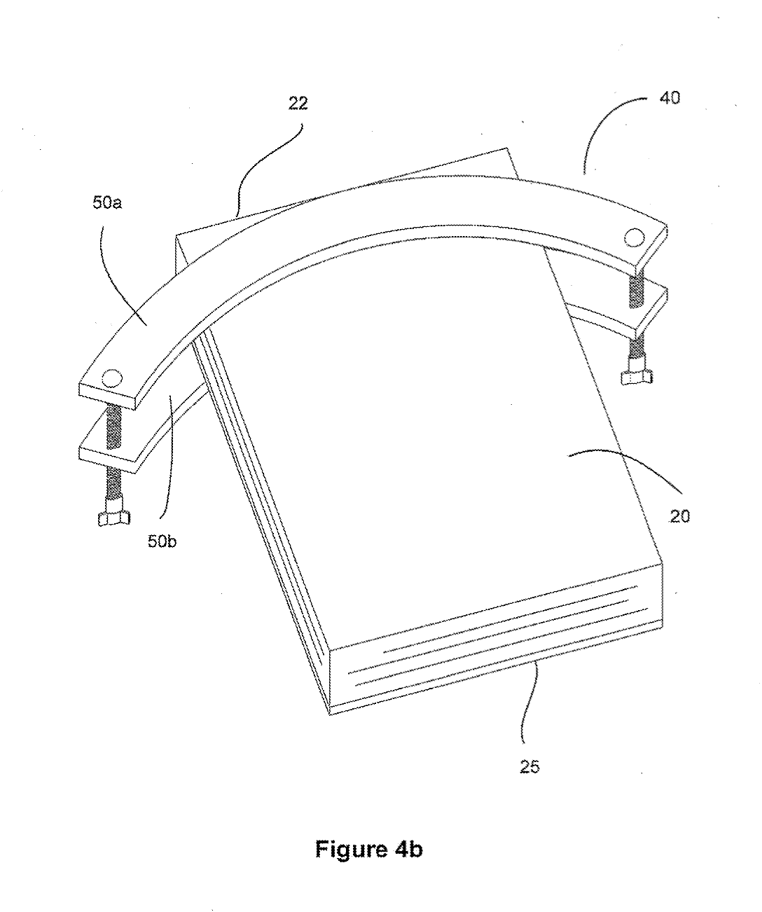

FIG. 4a illustrates a third exemplary embodiment of padding clamp 40. In the embodiment shown, padding clamp 40 contains pressurizing components 50a, 50b and tightening components 60a, 60b. In the embodiment shown, pressurizing components 50a, 50b are curved and are made of metal. In other embodiments, pressurizing components 50a, 50b may be of other shaped, such as rectangular, oval, elliptical, i-shaped, or square, and are made of a material other than metal, such as plastic.

Pressurizing components 50a, 50b contain apertures 55a, 55b, 55c, 55d sized to accommodate tightening components 60a, 60b. In the embodiment shown, tightening components 60a, 60b consist of screws 65a, 65b with heads 70a, 70b that are larger than apertures 55a, 55b and nuts 75a, 75b located on the other end of tightening components 60a, 60b. Nuts 75a, 75b are used to tighten pressurizing components 50a, 50. In other embodiments, tightening components 60a, 60b consist of components other than a screw and nut.

FIG. 4b illustrates a third exemplary embodiment of a padding clamp 40 clamped around paper 20. In the embodiment shown, pressurizing components 50a, 50b are curved. Also visible is backing 25. Once padding clamp 40 has been tightened, padding compound 10 is applied to edge 22 of paper 20 nearest padding clamp 40.

What is claimed is:

1. A system for creating personalized memo pads comprised of:
a plurality of sheets of memo-sized paper adapted to be arranged in a stacked unit, said stacked unit having a first edge, a second edge, a third edge, and a fourth edge;
wherein each of said plurality of sheets of memo-sized paper is adapted to fit in a standard personal printer;
at least one image capable of being transferred to each of said plurality of sheets of memo-size paper; and
at least one padding compound capable of creating a bound edge at said first edge of each sheet of said plurality of sheets of memo-sized paper.

2. The system of claim 1 which further includes a pressurizing component.

3. The system of claim 2 wherein said pressurizing component is a clamp.

4. The system of claim 1 wherein said plurality of sheets of memo-sized paper is comprised of paper having a basis weight ranging from 28 to 32 lbs.

5. The system of claim 1 which further includes a padding compound applicator.

6. The system of claim 5 wherein said padding compound applicator is a brush to which said padding compound will not adhere.

7. The system of claim 5 wherein said padding compound applicator is disposable.

8. The system of claim 5 wherein said padding compound applicator is a disposable sponge.

9. The system of claim 1 wherein said image is a digitized image.

10. The system of claim 1 which further includes a storage container.

11. The system of claim 1 which further includes a template for sizing said at least one image.

12. The system of claim 1 which further includes a database of images from which a user can select said at least one image.

13. The system of claim 1 wherein each of said plurality of sheets of memo-sized paper includes apertures for securing components.

14. The system of claim 13 wherein said securing components are selected from a group consisting of screws and pins.

15. The system of claim 1 wherein said at least one padding compound is refillable.

16. The system of claim 1 wherein said at least one padding compound is capable of being decorated by a decorating component selected from a group consisting of dye, paint, color, and glitter.

17. The system of claim 1 which further includes a plurality of marking devices selected from a group consisting of stamps, pens, paint applicators, and dye applicators.

18. A printing system comprised of:
a printer adapted to receive memo-sized paper;
an image file capable of being transferred to memo-sized paper;
a plurality of sheets of memo-sized paper adapted to be arranged in a stacked unit, said stacked unit having a first edge, a second edge, a third edge, and a fourth edge;
at least one padding compound capable of creating a bound edge at said first edge of each sheet of said plurality of sheets of memo-sized paper; and
a pressurizing component.

19. A system for creating personalized memo pads comprised of:
a box adapted to fit on a display;
a plurality of sheets of memo-sized paper adapted to be arranged in a stacked unit, said stacked unit having a first edge, a second edge, a third edge, and a fourth edge;
wherein each of said plurality of sheets of memo-sized paper is adapted to fit in a standard personal printer;
at least one padding compound capable of creating a bound edge at said first edge of each sheet of said plurality of sheets of memo-sized paper; and
a pressurizing component;
wherein said plurality of sheet of memo-size paper, said at least one padding compound, and said pressurizing component fit inside said box.

20. The system of claim 19 wherein said box is adapted to fit on a hanging display rack.
